(19) United States
(12) Patent Application Publication
(10) Pub. No.: US 2003/0067158 A1
(43) Pub. Date: Apr. 10, 2003

(54) Album leaf with insert

(75) Inventors: Dale F. McIntyre, Honeoye Falls, NY (US); Christopher C. Cegelski, Rush, NY (US); John K. McBride, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 09/973,031

(22) Filed: Oct. 9, 2001

(51) Int. Cl. B42D 15/00

(52) U.S. Cl. 283/67

(57) ABSTRACT

An image product assembly and method of making the assembly. A dual sided album leaf is made having a first ply layer and a second ply layer. The first and second ply layers each having an outer surface and an inner surface, said first and second ply layers are secured together so as to form a pocket therebetween. The outer surface of the first and/or second ply layer having at least one image formed thereon. An insert is provided having a size and configuration such that it can be placed within said pocket, said insert having information thereon that relates to said at least one image.

### FIELD OF THE INVENTION

The present invention relates to album leafs and more particularly to an album leaf having an insert having information relating to the images on the album leaf.

### BACKGROUND OF THE INVENTION

It is known from U.S. Pat. Nos. 5,791,692; 5,957,502 and 6,004,061 which disclose forming an integral album leaf from a single sheet that is folded back upon itself and firmly secured together. These references also teach the providing of holes on the side having the cut edge which can be used for placing of the integral album leaf into a binder. U.S. Ser. No. 09/685,397 entitled A System And Method For Making A Two Side Image by William Archie Jr., Frank Pincelli, Dale McIntyre and Joe Manico discloses a mechanism and method for producing integral album leafs formed from a single sheet folded back upon itself. This reference also discloses providing cuts within the album leaf such that items may being placed on the insert can be removed as desired. There is no means or mechanism for assuring that the item placed therein, securely is associated with the album leaf. The present invention is directed to providing an integral album leaf wherein additional information can be provided with respect to the image provided on the album leaf which is securely associated with that album leaf. In addition, the present invention provides a system whereby the information that is provided on the insert can be readily correlated with the images provided on the album leaf.

### SUMMARY OF THE INVENTION

In accordance with one aspect of the present invention there is provided an image product assembly, comprising:

a dual sided album leaf having a first ply layer and a second ply layer, the first and second ply layers each having an outer surface and an inner surface, the first and second ply layers are secured together so as to form a pocket therebetween, the outer surface of the first and/or second ply layer having at least one image formed thereon; and

an insert having a size and configuration such that it can be placed within the pocket, the insert having information thereon that relates to the at least one image.

In accordance with another aspect of the present invention there is provided a method of making an image product assembly, the image product assembly comprising a dual sided album leaf having a pocket for receiving and an insert, comprising the steps of:

selecting images for printing on the outer surface of the album leaf;

arranging the images in a predetermined format for the printing prior to printing;

printing the images in the predetermined format on the album leaf;

obtaining information relating to the selected images; and

printing the information on an insert that is to be placed within the packet, the information being printed on the insert that is to placed within the pocket.

In accordance with still another aspect of the present invention there is provided a method for automatically associating information on a first page of an album leaf having a plurality of images and a second page on the album leaf also having a plurality of images, comprising the steps of:

selecting images that are to be printed on the first and second pages;

obtaining information that is to be associated with respect to the images on the first and second pages; and

providing the information on an insert that is to be provided with the album leaf, the information being provided on the insert such that it can be readily associated with respect to its corresponding associated image.

In accordance with still another aspect of the present invention there is provided a method for making an image product assembly, the image product assembly comprising a dual sided album leaf having a pocket for receiving and an insert, comprising the steps of:

providing a media sheet for forming the album leaf, the media sheet having an inner surface and an outer surface, the outer surface having at least one image thereon, the sheet be divided into two section about a fold line such that when the media sheet is folded the album leaf is formed;

providing adhesive along at least the area adjacent the fold line defining a pocket area with the periphery the album leaf and at least one stop area;

placing the insert within the pocket area, the insert having projection for engaging the stop area for preventing the insert from being removed completely form the pocket; and

folding the media sheet so as to form the album leaf and capture the insert with the pocket area.

In accordance with yet another aspect of the present invention there is provided a computer software program for use by a consumer for making of an album leaf and associated information sheet such that when the software program is loaded onto a computer the software program will cause the computer to do the steps of:

a) provide to a remote service provider images that are to be placed on an album leaf; and

b) allow the user to make the information sheet on a local printer that is to be associated with the album leaf.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1A is a plan view of an integral album leaf and associated insert made in accordance with the present invention which illustrates the construction of the two associated pieces;

FIG. 1B is a partial enlarged cross section view as taken along line 1B-1B of FIG. 1A illustrating the construction of the album leaf and associated insert;

FIG. 1C is a view similar to FIG. 1A illustrating the associated insert in the fully inserted position within the album leaf;

FIG. 2A is a plan elevational view of an album leaf and an associated insert made in accordance with the present invention illustrating images provided on the album leaf and associated information provided on one side of the insert;

FIG. 2B is a view similar of FIG. 2A illustrating the back side of the album leaf and the back side of the associated insert;

FIG. 2C is a plan elevational view of one side of a modified insert also made in accordance with the present invention illustrating how the associated information may be associated with the images;

FIG. 3A is a view of a media sheet having images formed on one side prior to folding the media sheet to form the album leaf of FIG. 1;

FIG. 3B illustrates the step of applying an adhesive to an area of the media sheet for forming the album leaf made in accordance with the present invention prior to folding;

FIG. 3C illustrates folding of the media sheet of FIG. 3B to the almost completely folded position;

FIG. 3D is a view of the completed album leaf assembly;

FIG. 4A illustrates the step of applying an adhesive insert to an area of the media sheet for forming the album leaf made in accordance with a further embodiment of the present invention prior to folding;

FIG. 4B is view of the media sheet of FIG. 4A illustrating the media sheet in a beginning folded condition with the insert located for final assembly;

FIG. 4C is view of the media sheet of FIG. 4A in a nearly folded final condition forming the album leaf with it's associated insert located for completion of the album leaf assembly;

FIG. 4D is a cross sectional view of the adhesive insert of FIG. 4A taken along line 4D-4D;

FIG. 5 illustrates a system whereby album leafs and inserts may be made in accordance with the present invention;

FIG. 6 is a flow chart illustrating how integral album leaf and associated insert may be made in accordance with the present invention;

FIG. 7 illustrates and integral album leaf and associated insert of another modified embodiment also made in accordance with the present invention;

FIG. 8 is a plan view illustrating the album leaf and associated insert as placed in a binder for associating the images and associated data;

FIG. 9A illustrates yet another modified insert made in accordance with the present invention; and

FIG. 9B is a partial enlarged cross section view as taken along line 1B-1B of FIG. 1A illustrating the construction of the album leaf and the modified insert.

### DETAILED DESCRIPTION OF THE INVENTION

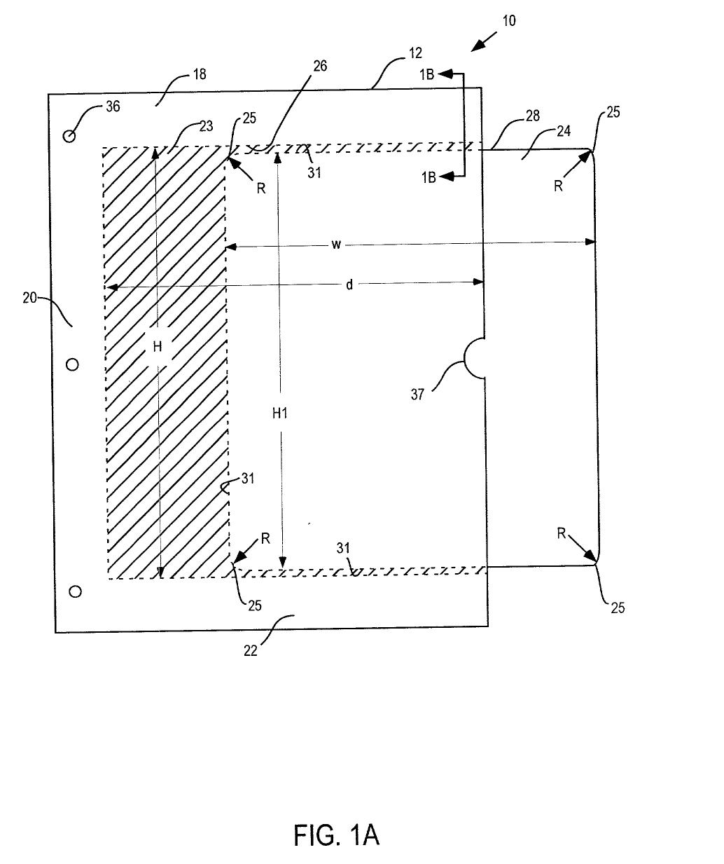

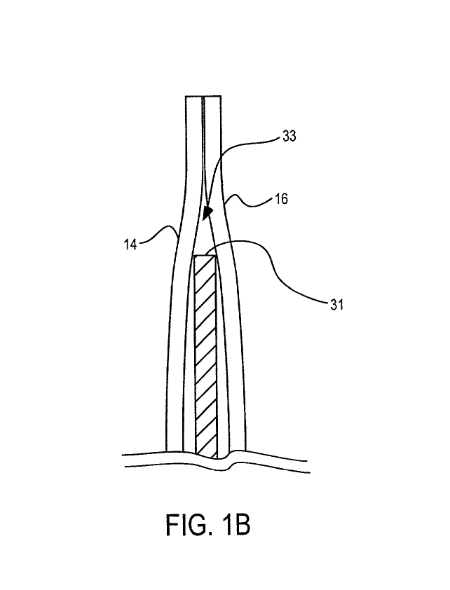

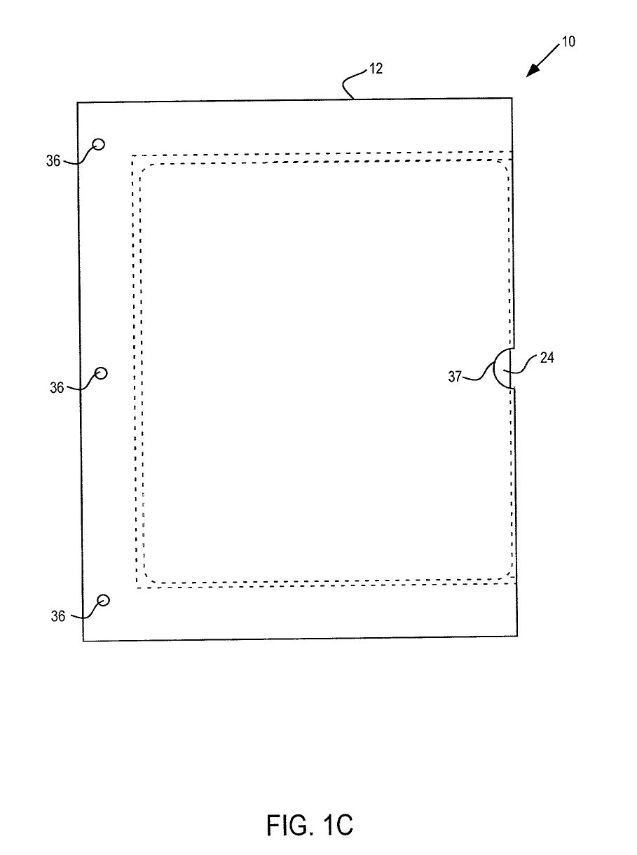

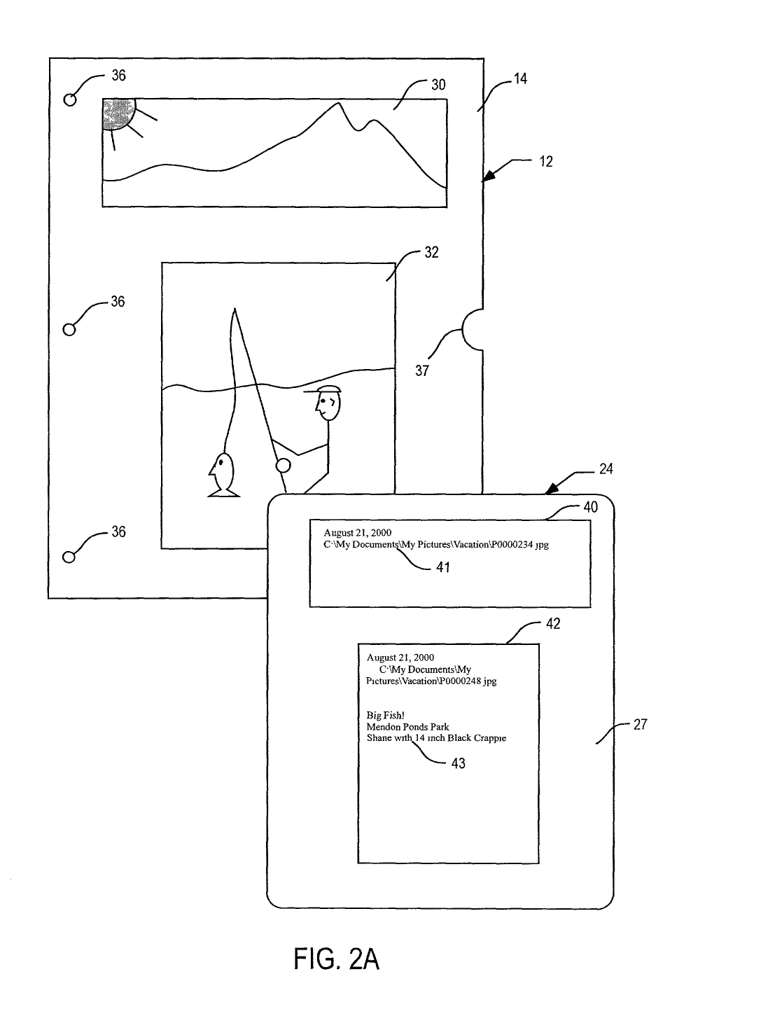

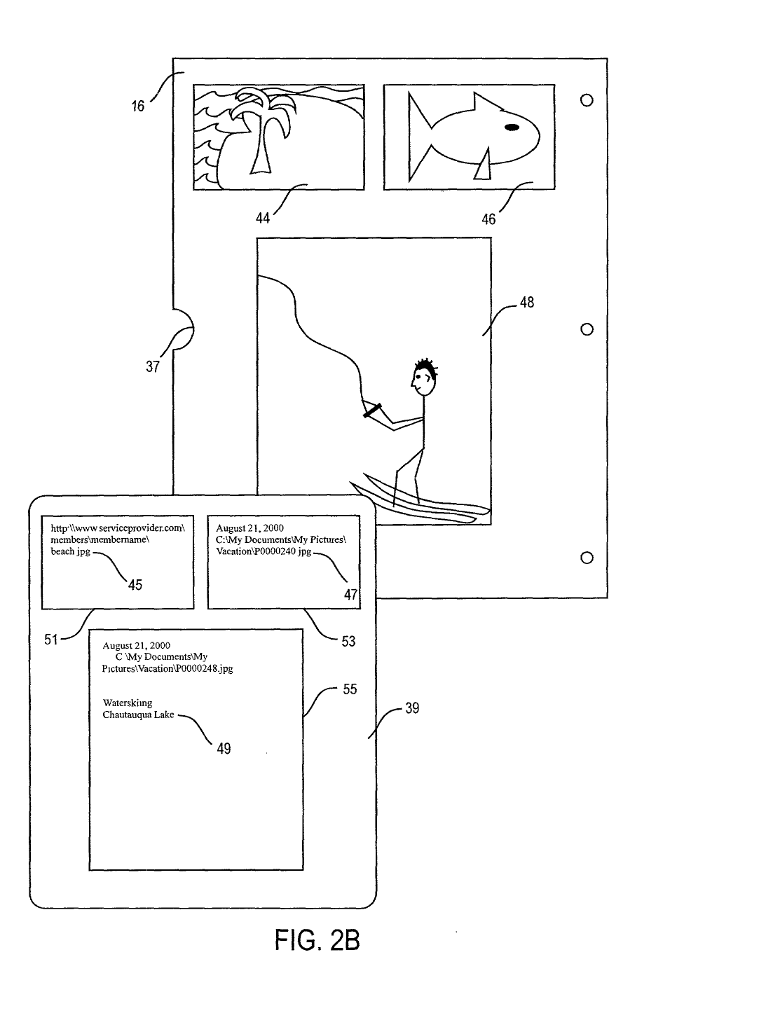

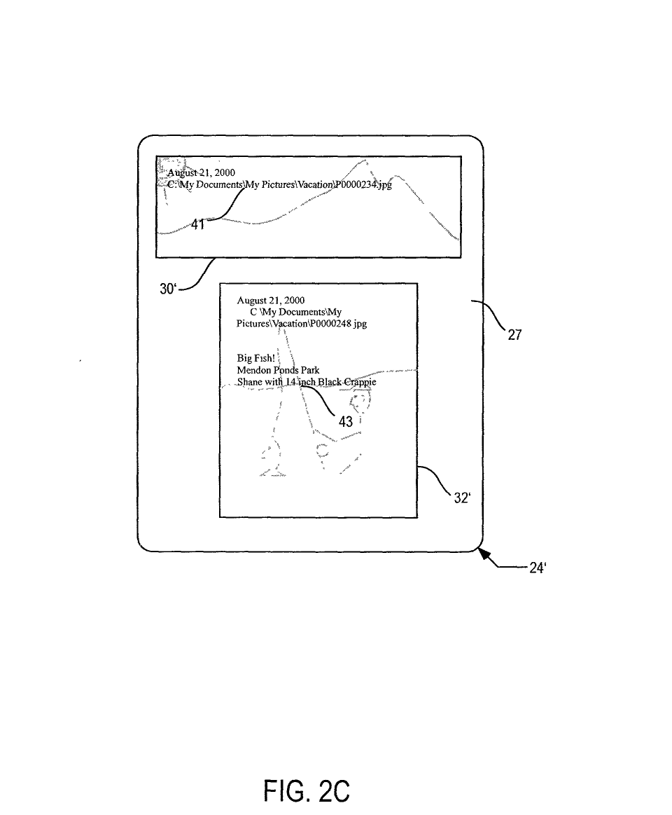

Referring to FIGS. 1A, 1B, 2A, and 2B, there is illustrated an album leaf assembly 10 made in accordance with the present invention. In the particular embodiment illustrated, the album leaf assembly 10 comprises an integral album leaf 12 comprising a first ply layer 14 that has inner surface and outer surface and second ply layer 16 having an inner surface and outer surface. The outer surface of the first and second ply layers 14, 16 form the front and back sides 15, 17 of the integral album leaf 12, respectively. The integral album leaf 12 is preferably formed from a single media sheet that is folded back upon itself and secured along the adhesive lateral edge areas 18, 20 and 22 so as to form a pocket 23 between ply layers 14 and 16 in which an insert 24 may be provided. In the particular embodiment illustrated, the media sheet is made from a photographic media, such as photographic paper, wherein images have been formed on the emulsion side of the paper. The adhesive lateral edge areas 18, 20 and 22 are configured such that a substantially rectangular pocket 23 is formed. The pocket 23 has a configuration such that the insert 24 may be easily placed therein, yet, of sufficient size to retain the insert within the pocket. Thus, the pocket 23 preferably has a height H and a depth d, which is slightly greater than the height H1 and with width W of insert 24. Thus an inner periphery 26 substantially surrounds an outer periphery 28 of the insert 24. As can be seen from FIGS. 1A, 1B, and 1C the width W and height H1 of the insert 24 is designed such that at least one of peripheral edges 31 of the insert 24 forms an interference lock at the juncture 33 of the pocket 23 with the ply layers 14 and 16 as illustrated. The inner periphery edge (juncture) 33 contacts with the ply layers 14, 16 such that a sufficient degree of force will allow easy removal of insert 24, yet provide sufficient degree of force to retain the insert 24 within pocket 23 when no substantial force is being applied to the insert 24. Since the width and thickness of the ply layers 14, 16 and insert 24 may be varied and the material from which they are made can also be varied, the degree of interference varies in response to these existing conditions. The corners 25 of the insert 24 are preferably rounded so as make it easy to insert and/or move the insert 24 within pocket 23. In the embodiment illustrated, the corners 25 have a radius R no less than ¼ of an inch. However, the exact length of radius R may vary in accordance with the physical properties of the insert and album leaf, thus the radius R may vary accordingly.

Referring to FIG. 2A, there is illustrated an integral album leaf 12 having images 30, 32 on the front side 15. As can be seen in the particular embodiment illustrated, a plurality of openings 36 are provided such that the album leaf 12 may be secured within a ring binder. Also, a cut-out section 37 is provided so that the insert 24 can be accessed easily when it is placed fully within pocket 23 (as shown by FIG. 1C). In the particular embodiment illustrated, the image 30 has a peripheral rectangular configuration which is typically referred to as being a panoramic aspect ratio and the image 32 illustrates an image having a typical classic aspect ratio wherein the long side is in the vertical direction. In the particular embodiment illustrated, the front side 27 of insert 24 has information/data 41, 43 to be associated with images 30, 32 respectively. In order to assist with the quick identification of the information with the images on the album leaf 12 it is associated, outlines 40, 42 that correlate to the respective images 30, 32 are provided that have substantially the same ratio as the images 30, 32 on the album leaf 12, respectively. In this way, by simply looking at the outlines 40, 42 it can be readily determined that the information 41 is associated with image 30 and the information 43 is associated with image 32. It is to be understood that similar type images may be provided on the back side 17 of the album leaf 12 and similar information may be provided on the back side 29 of the insert 24 as shown in FIG. 2B.

Referring now to FIG. 2B, there is illustrated the back side 17 of the album leaf 12 and the back side 29 of insert 24. As can be seen, the images 44, 46 and 48 are provided on the back side 17 of album leaf 12 and corresponding information 45, 47 and 49 are provided on the backside 29 of the insert 24 having respective outlines 51, 53 and 55. The outlines are relatively correlated in size and shape, and positioned on the insert 24 in the same general position as the images 44, 46, and 48 on the album leaf 12.

Referring to FIG. 2C, there is illustrated a modified insert 24′ also made in accordance with the present invention. The insert 24′ is similar to the insert 24 of FIG. 2A like numerals indicating like parts and operation as previously discussed. However, in this embodiment, a copy of the images 30, 32 are provided with the information written directly over the images on the insert 24′. In the preferred embodiment, the images 30, 32 are printed on insert 24′ of a lower color saturation (intensity) such that the information/data can be easily read by the viewer. This lower saturation image may be a sepia and/or color tone as appropriate. However, since the intensity of the image is substantially less, the information 41, 43 can be easily and clearly read. A benefit of this particular embodiment is that the information 41, 43 can be more readily associated with its associated image 30, 32 on the album leaf 12. This embodiment allows for the providing of substantially more information on the insert 24′ than would typically be available on the album leaf 12 without interfering with the viewing of the images.

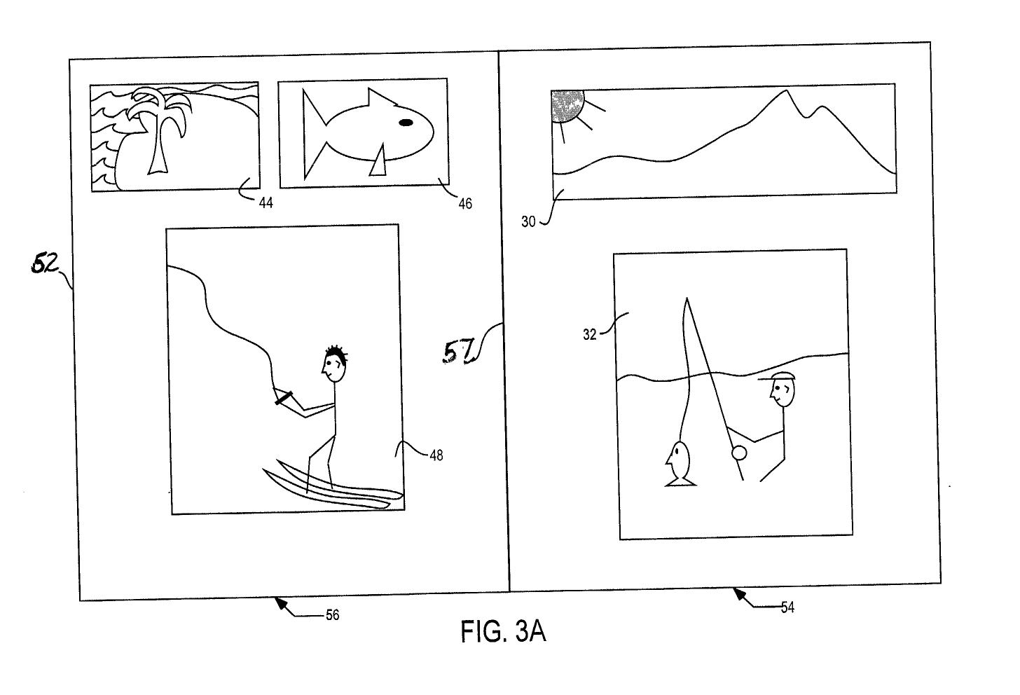

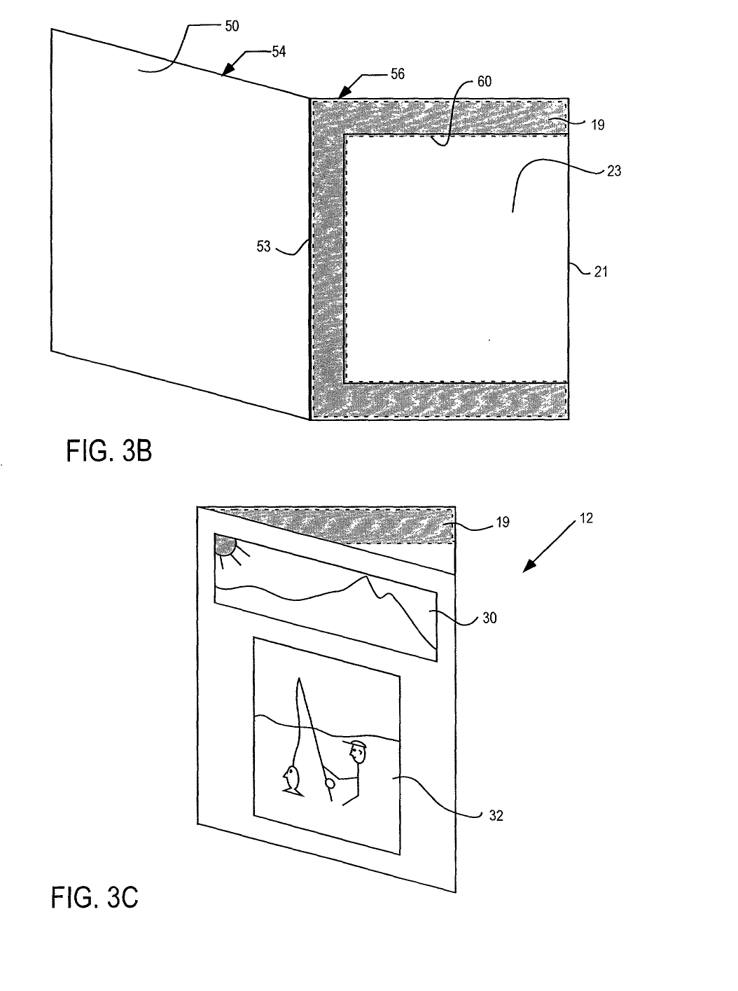

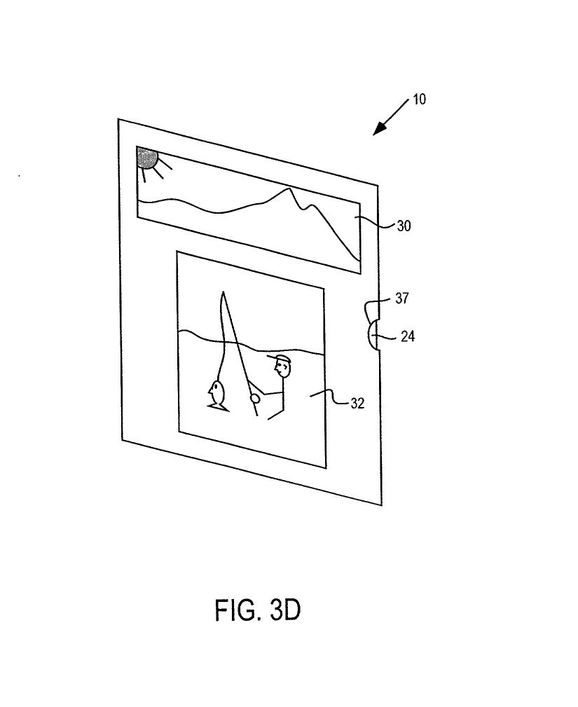

Referring to FIGS. 3A, 3B, and 3C, there is illustrated a first method for making the integral album leaf 12 in accordance with the present invention. In the particular embodiment illustrated, there is provided a media sheet 47 having two sections 54 and 56 separated by a fold line 53. Images 30, 32 are provided in section 54 and images 44, 46, and 48 are provided in section 56 as shown in FIG. 3A. The sections 54, and 56 are substantially identical in size and shape such that when the media sheet is folded about the fold line 53 an integral album leaf 12 is formed. It is of course understood that trimming operations may be provided to the folded integral album leaf 12 in a later operation so as to assure appropriate dimensional configuration of the integral album leaf 12. In the particular embodiment illustrated, inside surface 50 of section 56 is provided with an adhesive area 19, defined by dash line 60, such that when sections 54, 56 are brought together an integral album leaf with closed pocket 23 will be formed. The area 19 closely follows the configuration of the periphery of section 56. Thus, as can be seen, area 19 has generally a “C” configuration that forms an open area 21 for allowing insertion and removal of insert 24 from pocket 23. An adhesive is manually or automatically applied to area 19. Once the adhesive has been applied, the sections 54, 56 may be folded about fold line 53 as illustrated by FIG. 3A to form the complete integral album leaf 12 as illustrated by FIG. 2A.

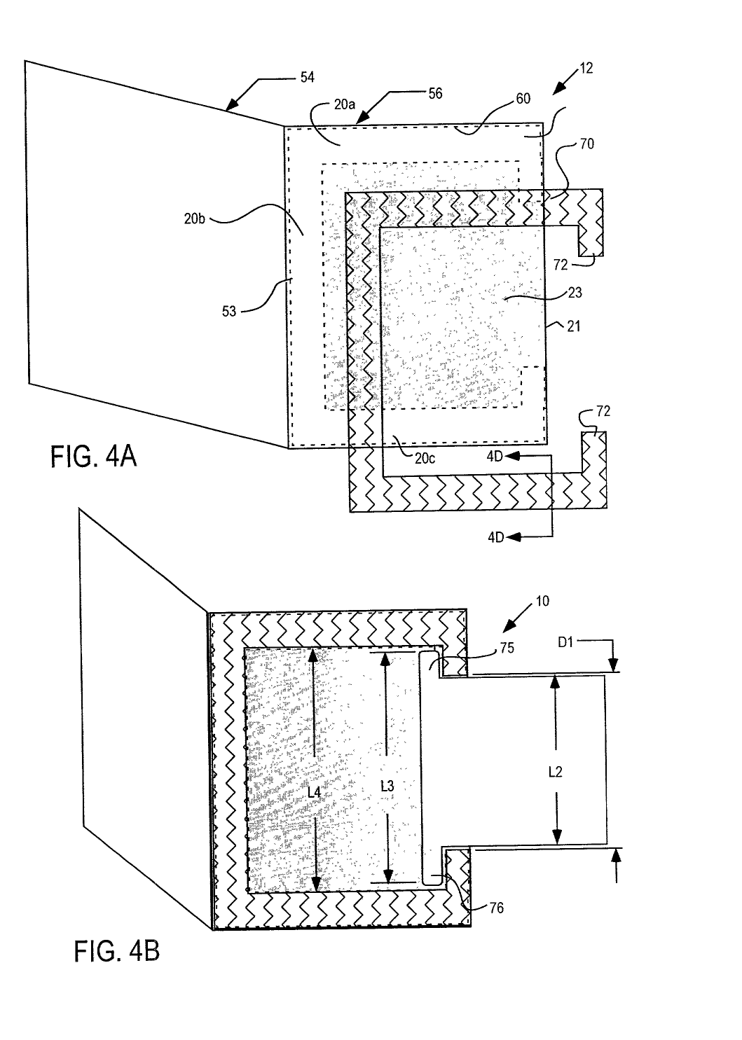

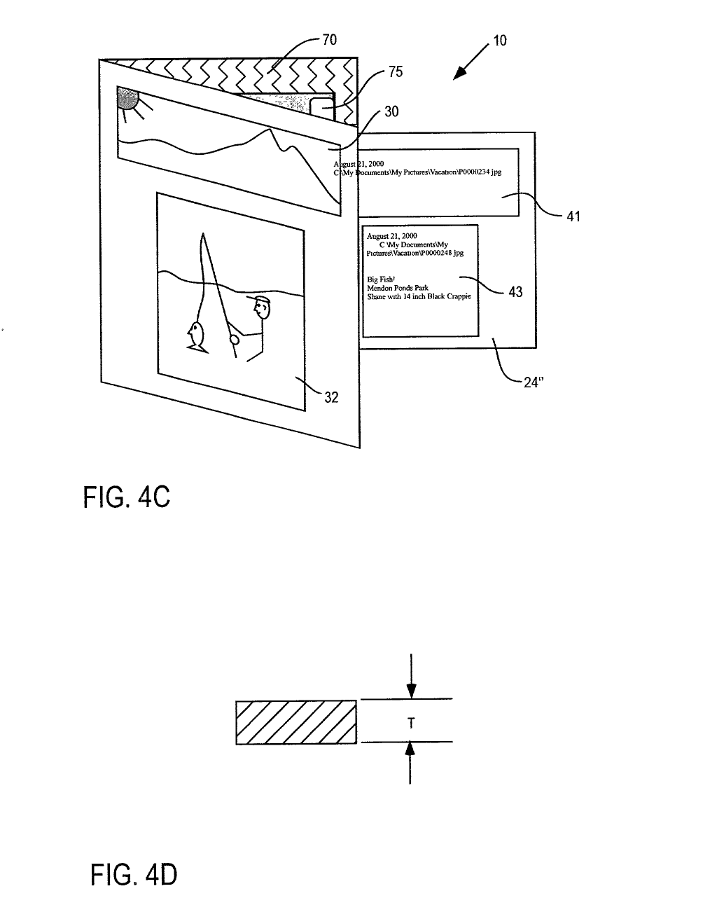

Referring to FIGS. 4A, 4B and 4C, there is illustrated a modified album leaf assembly 10 that comprises an integral album leaf 12 and insert 24″. Like numerals indicating like parts as previously discussed. In this particular embodiment, an adhesive insert 70 having a general C-shape configuration which corresponds to area 19 is provided for placement along the three sides 20a, 20b and 20c of area 19. In the particular embodiment illustrated, adhesive insert 70 is provided with a pair of projecting members 72 adjacent the opening 21 of pocket 23 which form stops against which insert 24″ will be stopped from further movement out of pocket 23 as discussed in detail later herein. The distance D1 between the projections 72, is greater than the length L2 of the main section of insert 24″. A pair of corresponding projections 75, 76 are provided on insert 24″ that are designed to engage projections 72 as illustrated. The length L3 of the portion of the insert 24″ having projections 75, 76 is less than the length L4 of the pocket 23. In the particular embodiment illustrated, the adhesive insert 70 has a thickness T which is substantially the same as the thickness T1 (not shown) of the insert 24″. In this way the insert 24″ can be easily moved into the storage position as illustrated by FIG. 3D to the fully extended position illustrated by FIG. 4C. However, if so desired, in place of adhesive insert 70 an adhesive may be placed directed on to area 19 therein and the insert 24″ may be held within the pocket 23 in the same manner as previously discussed. After the adhesive insert 70 has been placed in section 56, the insert 24″ is placed as illustrated in FIG. 4B. Thereafter section 54 is folded about fold line 53 as illustrated by FIG. 4A until completely folded to complete the album leaf assembly 10. Thus, it can be seen that the insert 24″ can only be removed by either breaking the projections on the album leaf 12 and or insert 24″.

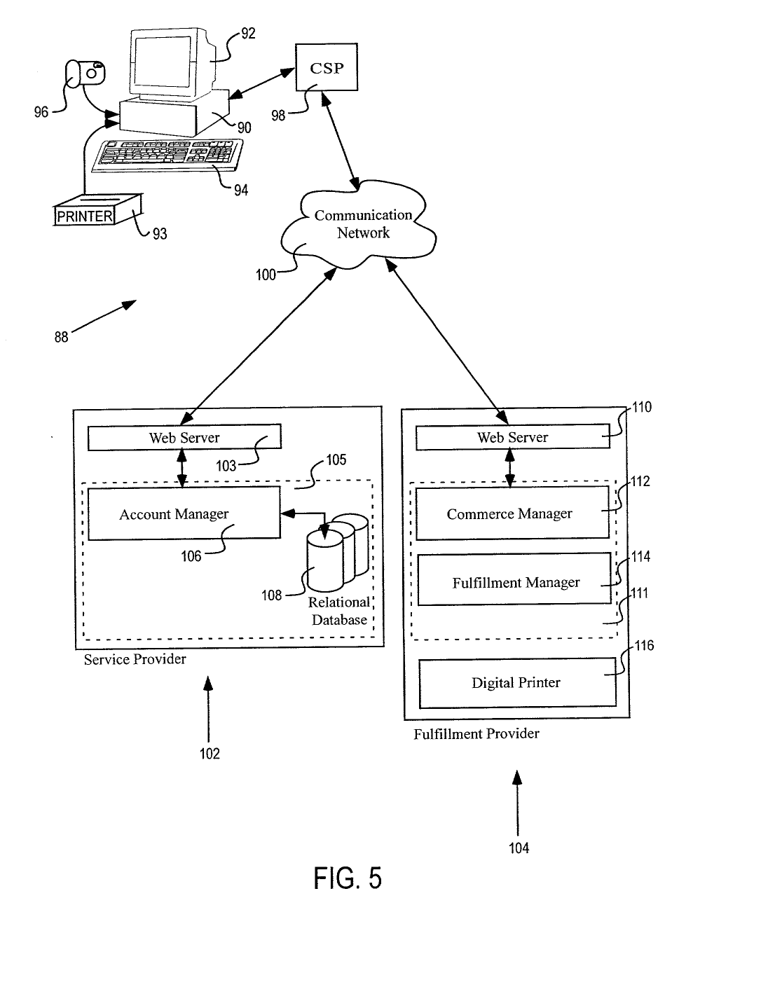

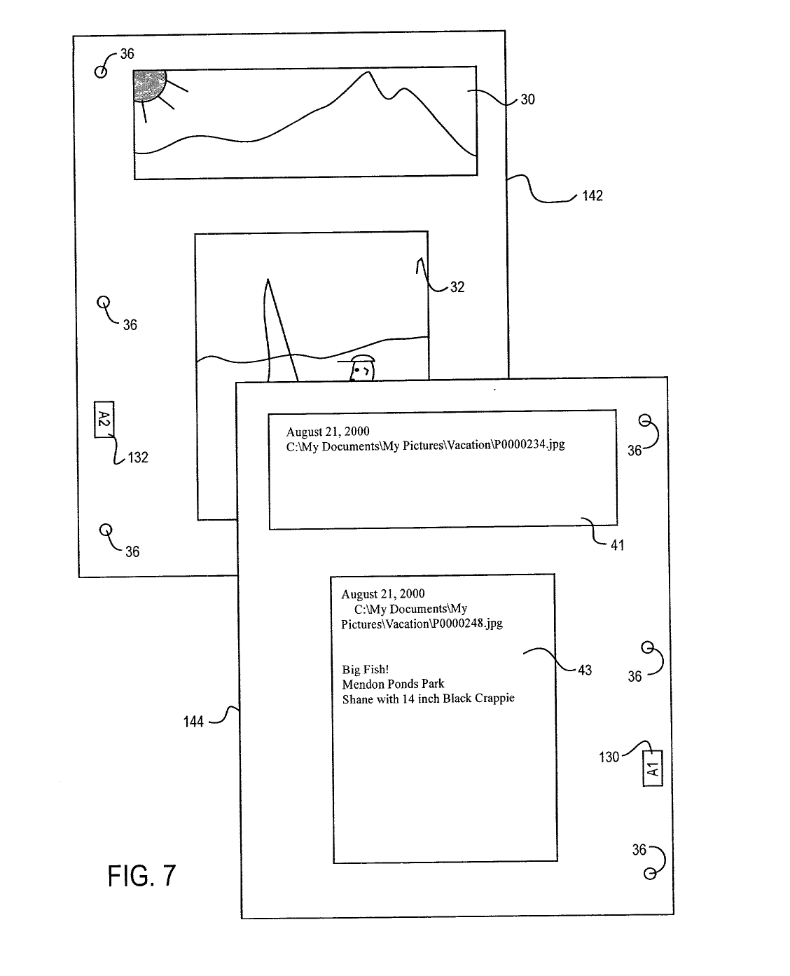

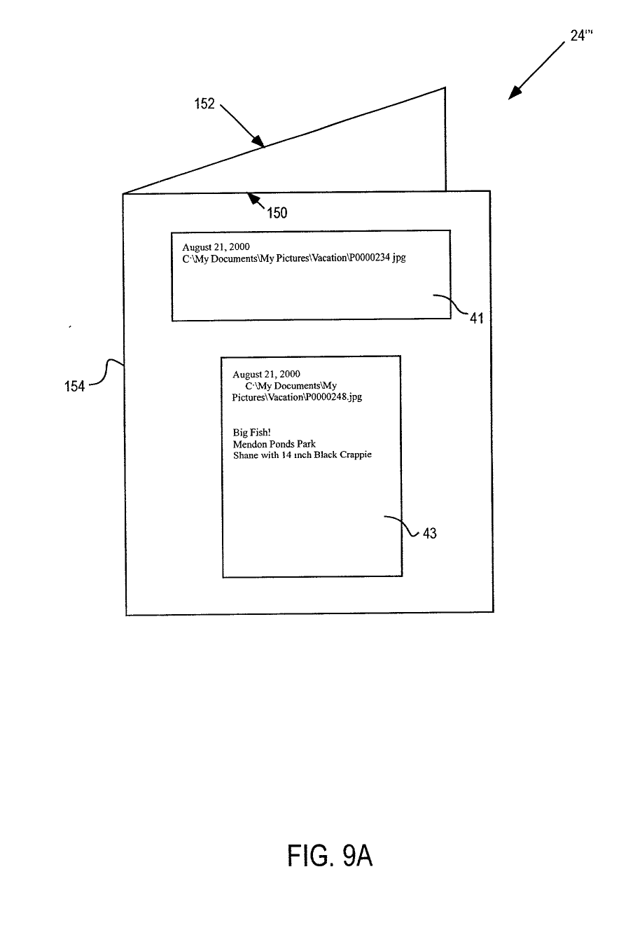

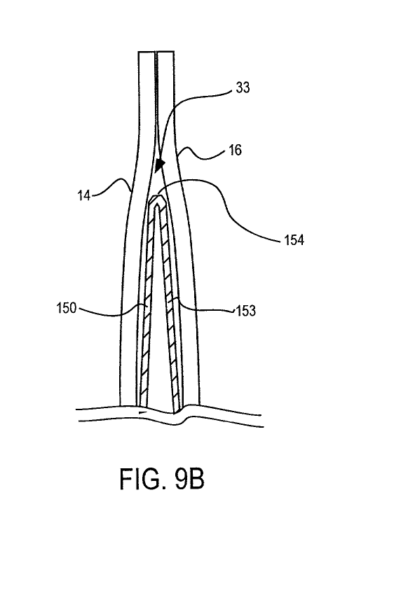

Referring to FIG. 5, there is illustrated a system 88 for making an album leaf assembly 10 in accordance with the present invention. In the particular embodiment illustrated, the system 88 includes a computer 90 having a display device 92, a data entry device 94 and a printer 93. In the particular embodiment illustrated, the display device 92 is a CRT and data entry device 94 is a keyboard or computer mouse. However, it is to be understood that any suitable device may be used for display device 92 and data entry device 94. Printer 93 is operably connected to computer 90 and can be used to form insert(s) 24, 24′, 24′″ (See FIG. 9A) or the sheet 144 (See FIG. 7). In the particular embodiment illustrated, images may be downloaded from a digital camera 96 or obtained in any appropriate manner, for example, but not limited to, over a communication network from a computer CD, computer disk etc. The computer 90 has appropriate communication capabilities and is connected to a consumer Communication Service Provider (CSP) 98 which allows the user of computer 90 to be connected to the communication network 100 which in this example is the Internet. This network communication connection allows computer 90 to be connected to a service provider 102 for the providing of digital image products which in turn may be part of or directly communicated to a fulfillment provider 104. In the particular embodiment illustrated, the service provider is illustrated as being connected to fulfillment provider 104 over the Internet. However, it is to be understood that the service provider and fulfillment provider can be the same entity.

The service provider 102 has a web server 103 which allows it to receive orders and images over a communication network 100, for example the Internet, from a customer using computer 90. An appropriate computer 105 is provided with an account manager functional block 106 for tracking individual consumer accounts. A memory storage database 108 is provided for the storing of digital images with respect to customers along with associated data that is provided by the customer. As orders and information are received, appropriate orders are built and forwarded to fulfillment provider 104 for the providing of various goods and/or service. In the particular embodiment illustrated, the fulfillment provider 104 would be the provider for printing of the media sheet 47 used to make the integral album leaf 12 and insert 24. In the particular embodiment illustrated, the fulfillment provider 104 has a web server 110 for receiving orders, digital data and further information for fulfilling of orders which passes the information on to a managing computer 111 which includes a two functional blocks 112, 114 for managing the received orders and creating the appropriate workflow to fulfill the products requested in the orders. The commerce manager 112 and fulfillment manager 114 may be provided by a single managing computer 111 as illustrated or by separate computers acting cooperatively. Appropriate printing devices are provided. Device 116 is provided for printing of the media sheet 47 containing the images and insert 24. Appropriate folding and cutting mechanisms not shown, are provided for forming of the integral album leaf 12 and insert 24 as previously discussed. Once the insert 24 and associated integral album leaf 12 have been formed, they will be forwarded to the customer through any appropriate means for example, but not limited to, mail delivered to a retail store or directly to the customer or designee. In the particular embodiment illustrated, there is illustrated in FIG. 5, orders being placed directly from a customer from a customer computer 90. However, it is to be understood that the computer 90 may be a kiosk at a retail location at which a customer has access.

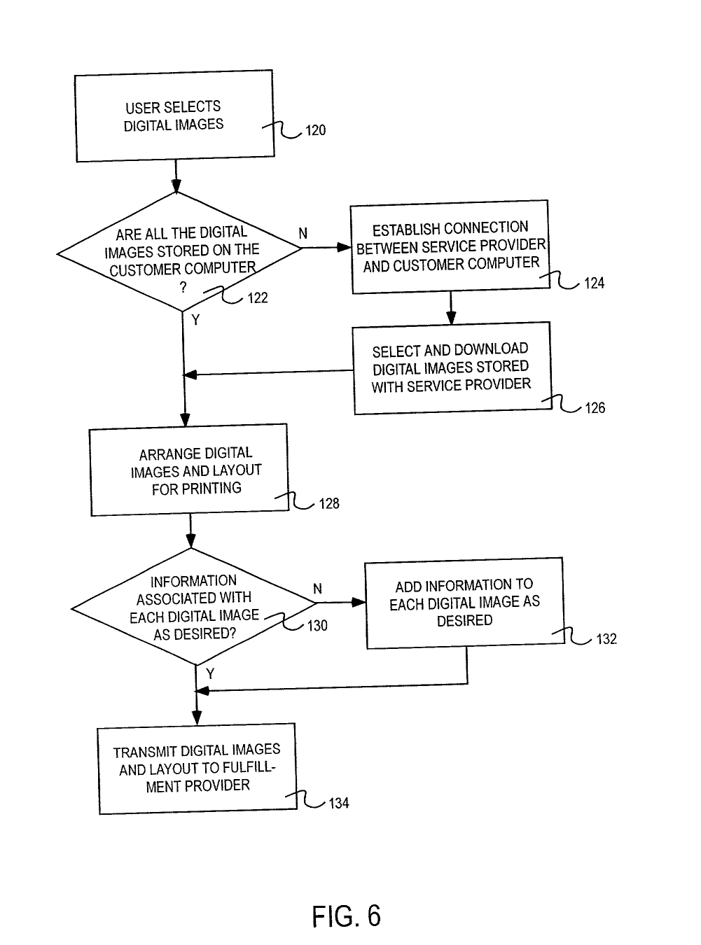

Referring to FIG. 6, there is illustrated a flow chart illustrating how a customer would order an integral album leaf 12 and associated insert 24. At step 120, the customer/user using computer 90 selects the desired digital image or images for placement on the integral album leaf 12. As a part of this first step, the user determines whether the images are stored on the local computer or need to be obtained from an alternate storage as in step 122. If they are not retained at the local computer, a connection is established at step 124 between the user and the service provider 102 where the images are provided. At step 126, the images are obtained by the customer. At which point in step 128, the user/customer arranges the digital images for laying out and forming the integral album leaf 12. At step 130, the user/customer provides associated information with desired images. Preferably, this associated information can be automatically retrieved upon image selection from information previously stored with the images on the customer computer 90 using commonly available software such as Image Expert 2000 from Conexant Inc. Alternatively, the consumer can provide the information after selecting the desired images. This information, along with the necessary images, are transmitted at step 134 to the service/fulfillment providers 102, 104 for fulfilling of the order.

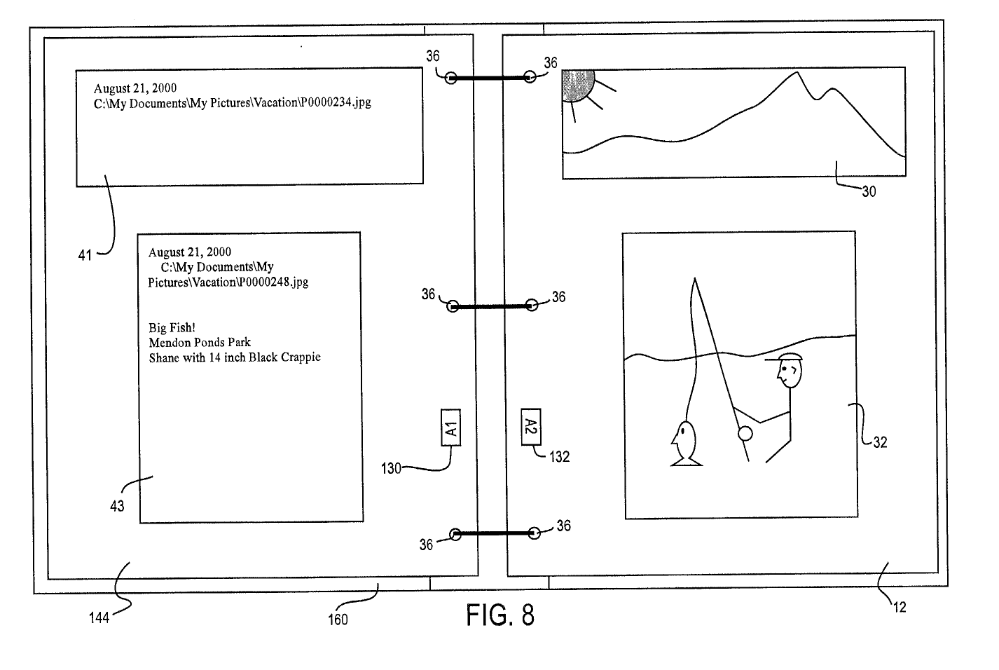

Referring to FIG. 7, there is illustrated a modified integral album leaf 142 and associated information sheet 144 made in accordance with the present invention. In the embodiments previously illustrated, the insert is provided directly in association with a pocket provided with the integral album leaf 12. However, in this embodiment the information is provided on a separate and discrete sheet 144. It should be noted that album leaf 12 in this embodiment need not have a pocket to retain an insert 24 as in earlier embodiments. In this embodiment, the information is provided on sheet 144 in the same manner as previously discussed with respect to insert 24 of FIGS. 2A, 2B and 2C. However, in this embodiment, the information is provided on a sheet also having holes 136 for permitting the sheet 144 to be placed in an album binder 160 adjacent to the album leaf 12 to which it is correlated. As illustrated by FIG. 8, the information would be provided on the sheet 144 adjacent to the images on integral album leaf 12. The information 41, 43 is printed on the sheet 144 in a format so that the information 41, 43 can be readily associated with respect to the images 30, 32 on the album leaf 12 which it corresponds to as previously discussed. It is to be understood that the information on the sheet 144 can be provided on both sides and that this information can be associated with the particular images. To assure that these images can be readily associated again with the respected images a code 130, 132 may be provided on the sheet 144 and integral album leaf 142 so that they can be associated together. This can be in the form of a number, symbol, or code. However, in an alternate form of embodiment, as discussed previously, with respect to FIG. 2C a low resolution or intensity image copy of the original image is provided thereon. Thus in this embodiment even if the sheet 144 is disassociated with the integral album leaf 112, they can be readily associated again.

In the embodiments illustrated, the insert 24 has been made of single integral sheet having images formed on both sides. It is to be understood that insert 24 may also be made of a two ply structure in the same manner as album leaf 12. For example, but not by way of limitation, the insert 24 may be made from a single sheet that is folded into at least two distinct folded sections 150, 152. The two folded sections 150, 152 can be secured together or left slightly apart as shown in FIG. 9A. The sections 150, 152 provide a small resistance from being completely folded adjacent each other.

In this manner when the insert 24′″ is placed in album leaf 12, a slight retaining force caused by the sections 150, 152 being biased apart will assist in retaining the insert 24′″ within the pocket 23. The cross sectional view presented by FIG. 9B illustrates how an insert 24′″ inserted into the album leaf 12 of FIG. 1A would look if taken along the lines 1B-1B like numerals indicating like parts and operation. Ply layers 14, 16 form juncture 33 where the peripheral edge of the fold 154 is seated and forces insert sections 150, 152 against ply layers 14, 16 of album leaf 12.

As previously discussed the album leaf 12 is made of a photographic paper. Likewise, the insert 24 may also be made of a photographic media. However, the present invention is not limited to printing images on photographic media. Any suitable media on which images may be formed may be utilized, for example but not by way of limitation, thermal media, ink jet media, etc. In this manner, software operating the computer 90 of system 88 (FIG. 5) can prepare and transmit electronically, preferably over the internet, images to a remoter service provider 102 and fulfillment provider 104 in the manner previously described to form the album leaf 142. Subsequent operation of the computer software then causes the information associated with the images to be formed on a information sheet 144 such as an ink jet media that is printed by the user's own local printer 93 (FIG. 5) such as an ink jet printer. An appropriate code may be associated with the album leaf and information sheet so that they can be easily associated easily when the album leaf is received from the provider. In addition the information on the sheet can be associated with the images on the album leaf as previously described.

It is to be understood that various changes and modifications may be made without departing from the scope of the present invention. The present invention being defined by the claims that follow.

### PARTS LIST

10 album leaf assembly

12 integral album leaf

14 first ply layer

15 front side

16 second ply layer

17 back side

18 adhesive lateral edge area

19 adhesive area

20 adhesive lateral edge area

20a side

20b side

20c side

21 open area

22 adhesive lateral edge area

23 pocket

24 insert

24′ insert

24″ insert

25 corners

26 inner periphery

27 front side

28 outer periphery

29 back side

30 images

31 peripheral edge

32 images

33 peripheral edge

36 openings

37 cut-out section

40 outlines

41 information/data

42 outlines

43 information/data

44 images

45 information

46 images

47 information

48 images

49 information

50 inside surface

51 outlines

52 media sheet

53 outlines

54 section

55 outlines

56 section

57 fold line

60 dash line

70 insert

72 projecting member

75 projections

76 projections

88 system

90 computer

92 display device

93 printer

94 entry device

96 digital camera

98 Communication Service Provider

100 network

102 service provider

103 web server

104 fulfillment provider

105 computer

110 web server

111 computer

112 blocks

114 blocks

116 device

122 step

124 step

126 step

128 step

130 code

132 code

134 step

136 holes

142 integral album leaf

144 sheet

150 sections

152 sections

What is claimed is:

1. An image product assembly, comprising:
a dual sided album leaf having a first ply layer and a second ply layer, said first and second ply layers each having an outer surface and an inner surface, said first and second ply layers are secured together so as to form a pocket therebetween, said outer surface of said first and/or second ply layer having at least one image formed thereon; and
an insert having a size and configuration such that it can be placed within said pocket, said insert having information thereon that relates to said at least one image.

2. An image product assembly according to claim 1, wherein said outer surface of said first or second ply layer having a plurality of images formed thereon, said information on said insert is located in a position such that it can be readily identified with respect to which of said plurality of images it is associated.

3. An image product assembly according to claim 2, wherein said information is correlated with respect to its associated image by providing a copy of said associated image at a reduced copy having reduced visual characteristics.

4. An image product assembly according to claim 1, wherein said outer surface of said first and second ply each have a plurality of images and said insert having information with respect to said images on said first and second surfaces, said information being provided on said insert.

5. An image product assembly according to claim 1, wherein said insert is provided with a retaining member that prevents the insert from being pulled completely out of said pocket.

6. An image product assembly according to claim 5, wherein said retaining member comprises a pair of dog ears disposed at opposite ends of said insert, the dog ears being designed to be stopped by a retaining section in said leaf.

7. An image product assembly according to claim 1 wherein insert is folded such that when it is placed within said pocket it causes said insert to be retained within said pocket.

8. An image product assembly according to claim 1, wherein said first and second ply layers each comprise four sides and said first and second ply layers are secured together along three of said four sides.

9. An image product assembly according to claim 8, wherein an adhesive is used to secure said first and second ply layers together.

10. An image product assembly according to claim 8, wherein a generally u-shaped member is positioned along three of said four sides is provided for securing said first and second ply layers together.

11. An image product assembly according to claim 10, wherein an adhesive is applied to the inner surface of said first and second ply layers.

12. An image product assembly according to claim 1, wherein said first and second ply layers are formed by folding a single sheet.

13. A method of making an image product assembly, said image product assembly comprising a dual sided album leaf having a pocket for receiving and an insert, comprising the steps of:
selecting images for printing on said outer surface of said album leaf;
arranging said images in a predetermined format for said printing prior to printing;
printing said images in said predetermined format on said album leaf;
obtaining information relating to said selected images; and
printing said information on an insert that is to be placed within said packet, said information being printed on said insert that is to placed within said pocket.

14. A method according to claim 13, wherein said information printed on said insert is provided so that said information can be readily identified with respect to its associated image.

15. A method according to claim 14, wherein said images are printed on said insert at a location that is associated with the same location on said album leaf.

16. A method according to claim 14, wherein the means for readily identifying said information and its associated images comprises printing said information on a copy of said image having reduced visual characteristics.

17. A method according to claim 13, wherein said information is associated with said images is obtained at the time said images are arranged in said predetermined format.

18. A method according to claim 13, wherein said dual album leaf is made by folding a sheet back on itself and securing a portion of the periphery of said album leaf.

19. A method according to claim 14, wherein said information is automatically printed on said insert so that said information is readily identified with the image it relates to.

20. A method for automatically associating information on a first page of an album leaf having a plurality of images and a second page on said album leaf also having a plurality of images, comprising the steps of:
selecting images that are to be printed on said first and second pages;
obtaining information that is to be associated with respect to said images on said first and second pages; and
providing said information on an insert that is to be provided with said album leaf, said information being provided on said insert such that it can be readily associated with respect to its corresponding associated image.

21. A method according to claim 20, wherein said associating of said information is accomplished by printing said in a corresponding location on said insert.

22. A method according to claim 21, wherein said information is written within an outline of the corresponding image to which said information relates, said outline having the substantially same aspect ratio and location that said associated image has on said first or second page.

23. A method according to claim 20, wherein said information is related to said associated image by providing said information on a copy of said image having reduced visual characteristics of said associated image.

24. A method for making an image product assembly, said image product assembly comprising a dual sided album leaf having a pocket for receiving and an insert, comprising the steps of:
providing a media sheet for forming said album leaf, said media sheet having an inner surface and an outer surface, said outer surface having at least one image thereon, said sheet be divided into two section about a fold line such that when said media sheet is folded said album leaf is formed;
providing adhesive along at least the area adjacent the fold line defining a pocket area with the periphery said album leaf and at least one stop area;
placing said insert within said pocket area, said insert having projection for engaging said stop area for preventing said insert from being removed completely form said pocket; and
folding said media sheet so as to form said album leaf and capture said insert with said pocket area.

25. A computer software program for use by a consumer for making of an album leaf and associated information sheet such that when said software program is loaded onto a computer said software program will cause said computer to do the steps of:
a) provide to a remote service provider images that are to be placed on an album leaf; and
b) allow the user to make said information sheet on a local printer that is to be associated with said album leaf.

26. A computer software program according to claim 25 wherein said album leaf and said information sheet is designed to be placed adjacent each other.

27. A computer software program according to claim 25 wherein said information sheet is designed to be placed within a pocket provided in said album leaf.

28. A computer software program according to claim 25 wherein said information sheet has information that can be used for associating information provided on said information sheet with said images on said album leaf.

29. A computer software program according to claim 25 wherein said information sheet has information that can be used for said album leaf with said information sheet.

30. A computer software program according to claim 29 wherein said information comprises a code supplied by said software program.

31. A computer software program according to claim 30 wherein said code is printed on said album leaf and said information sheet.
